(19) United States
(12) Patent Application Publication
(10) Pub. No.: US 2014/0299111 A1
(43) Pub. Date: Oct. 9, 2014

(54) VENTING SYSTEM FOR A FUEL TANK

(71) Applicant: Helmut Denz, Stuttgart (DE)

(72) Inventor: Helmut Denz, Stuttgart (DE)

(73) Assignee: Robert Bosch GmbH, Stuttgart (DE)

(21) Appl. No.: 14/238,836

(22) PCT Filed: Aug. 1, 2012
(86) PCT No.: PCT/EP2012/065034

§ 371 Date: May 12, 2014

(30) Foreign Application Priority Data
Aug. 18, 2011 (DE) 10 2011 081 171.0
Nov. 23, 2011 (DE) 10 2011 086 946.8

(51) Int. Cl. F02M 25/08; F02M 35/10

(52) U.S. Cl. CPC F02M 25/0836; F02M 35/10157
USPC 123/521; 123/184.47

(57) ABSTRACT

A venting system for a fuel tank includes a sorption filter for temporarily storing fuel evaporating from the fuel tank and a delivery device arranged between the sorption filter and an air supply system of an internal combustion engine in a fluid-conducting manner. The internal combustion engine is a turbocharged engine with a turbocharger unit and a throttling device in the air supply system. The sorption filter is connected to the air supply system in a fluid-conducting manner by a first line at a first inlet point arranged upstream of the turbocharger unit and by a second line at a second inlet point arranged downstream of the throttling device. A tank venting valve is arranged in the second line, and the first line branches off from the second line upstream of the tank venting valve in the flow direction towards the second inlet point.

### PRIOR ART

The invention relates to a venting system for a fuel tank, having a sorption filter for the temporary storage of fuel evaporating from the fuel tank and having a fluid line between the sorption filter and an air supply system of an internal combustion engine. The invention also relates to a venting system for a fuel tank, having a sorption filter for the temporary storage of fuel evaporating from the fuel tank and having a delivery device which is arranged in fluid-conducting fashion between the sorption filter and an air supply system of an internal combustion engine. Finally, the invention also relates to the use of a venting system of said type on a motor vehicle.

In a fuel tank of a motor vehicle, depending on the pressure and temperature conditions prevailing in the fuel tank and a composition of the fuel, volatile substances evaporate, said volatile substances including mainly hydrocarbons and other volatile components in smaller fractions. For environmental protection reasons and for safety, said substances must be captured and supplied to the engine for combustion. For this purpose, the volatile substances are generally adsorbed and temporarily stored by means of an activated carbon filter. For the regeneration or desorption of the activated carbon filter, the substances are drawn off by means of a fluid flow—generally fresh air—and supplied to an intake pipe, positioned upstream of the internal combustion engine, for combustion. Here, the drawing-off process occurs under the action of negative pressure that is generated in the intake pipe owing to throttling of the engine.

In the case of turbocharged engines, hybrid vehicles and engines which operate the engine with the greatest possible level of dethrottling in order to reduce fuel consumption, there is the basic problem that conventional fuel tank venting by means of a negative pressure in the intake pipe does not yield adequate regeneration of the activated carbon filter.

Legislation in some countries also demands checking of the functionality of fuel tank venting systems in motor vehicles by way of on-board means, that is to say a so-called on-board diagnosis (OBD). As part of the on-board diagnosis, it is necessary for any leaks to be identified and signaled and for corresponding data to be provided to an on-board memory for an off-board diagnosis to be performed in a workshop.

DE 101 54 360 A1 discloses a treatment system for evaporating fuel, having a purging duct for providing a connection between an intake pipe of an internal combustion engine and a fuel tank. In an intermediate part of the purging duct there is provided a canister for temporarily adsorbing evaporated fuel which is generated in the fuel tank. Furthermore, a purging pump is provided in a section of the purging duct, wherein the purging pump is designed to deliver evaporating fuel from the canister to the intake pipe. After the closure of an atmospheric air inlet valve of the canister, the operation of the purging pump is interrupted when the negative pressure in the fuel tank has reached a predetermined value owing to the operation of the purging pump. After the stoppage of the purging pump, a flow control valve provided on the intake pipe or in the vicinity thereof is closed. If a change in the pressure in the fuel tank is identified after a predetermined time period has elapsed, the entire purging duct is examined with regard to a fault.

Furthermore, DE 197 35 549 A1 discloses a device for the diagnosis of a fuel tank venting system of a vehicle having a fuel tank and an adsorption filter which is connected to the fuel tank via a fuel tank connection line. For venting, the fuel tank ventilation system comprises a tank venting valve which is connected to the adsorption filter via a valve line. A switching means applies a pressure from an on-board pressure source to the fuel tank venting system and to a reference leakage alternately, and in this way determines any leakage.

It is an object of the invention to provide a venting system, which is inexpensive to produce, for a fuel tank, which venting system firstly permits good regeneration or desorption of the sorption filter and secondly ensures on-board diagnosis of any leakage in the fuel tank venting system.

### DISCLOSURE OF THE INVENTION

According to the invention, there is provided a venting system for a fuel tank, having a sorption filter for the temporary storage of fuel evaporating from the fuel tank and having a delivery device which is arranged in fluid-conducting fashion between the sorption filter and an air supply system of an internal combustion engine, wherein the internal combustion engine is a turbocharged engine with a turbocharger unit and with a throttle device, in particular in the form of a throttle flap, in the air supply system, the sorption filter is connected in fluid-conducting fashion via a first line to the air supply system at a first infeed point positioned upstream of the turbocharger unit and is connected in fluid-conducting fashion via a second line to the air supply system at a second infeed point positioned downstream of the throttle device, a tank venting valve is arranged in the second line, and the first line branches from the second line upstream of the tank venting valve as viewed in the flow direction to the second infeed point.

The venting system according to the invention is suitable in particular for use in the case of turbocharged engines, preferably in the case of downsized turbocharged engines which, with smaller and more lightweight engines, ensure engine performance similar to that of conventional engines of larger displacement. The delivery device serves to overcome the problem that turbocharged engines generate a relatively low intake negative pressure across the intake pipe owing to a dethrottled manner of operation, which intake negative pressure is often not great enough to fully regenerate the sorption filter. For this purpose, the delivery device is connected in fluid-conducting fashion via a first line to the intake pipe at an infeed point positioned upstream of the turbocharger unit and is connected in fluid-conducting fashion via a second line to the intake pipe at a infeed point positioned downstream of the throttle device. The venting system then has two infeed points via which the evaporated fuel that is desorbed from the sorption filter can be supplied to the engine. If the pressure prevailing in the purging line is higher than the pressure in the intake pipe, that is to say that the internal combustion engine is being operated in a throttled manner with negative pressure in the intake pipe, the regeneration takes place, with the delivery device deactivated, into the intake pipe. By contrast, when the engine is operated in the load range, that is to say with a positive pressure in the intake pipe, the delivery device is activated and the purging fluid enriched with volatile fuel components is supplied to the engine via the infeed point positioned upstream of the turbocharger unit. It is thus possible for the delivery device to operate with lower pump power because the pressure at said infeed point is equal to ambient pressure and thus, during charged operation, is lower than the pressure at the infeed point positioned downstream of the throttle device. It is thus possible for the delivery device to be activated during charged operation only if a high loading is present in the activated carbon filter.

Owing to the branch, provided according to the invention, of the first line from the second line upstream of the tank venting valve as viewed in the flow direction, the delivery device is situated only in the first line, or in the regeneration line that leads to a point upstream of the turbocharger unit. The delivery device thus does not hinder the regeneration via the second line which leads into the intake pipe. The regeneration rate into the intake pipe does not require the delivery device, but rather can be controlled by means of the tank venting valve. The clock-pulse rate required for the actuation of the tank venting valve can advantageously be determined by means of a differential pressure measurement across the tank ventilation valve. The differential pressure is determined as a difference between the pressure upstream of the tank venting valve and the pressure downstream of the tank venting valve. The pressure upstream of the tank venting valve is the pressure in the tank and in the first line (generally approximately ambient pressure). The pressure downstream of the tank venting valve is approximately the pressure in the intake pipe.

If there is insufficient negative pressure in the intake pipe for the regeneration of the sorption filter, then it is possible, in particular owing to the brushless direct-current motor selected according to the invention, for the delivery rate of the delivery device to be slowly increased. Here, the regeneration rate in the first line can be controlled in continuously variable fashion. It is at the same time possible for the regeneration rate to be determined approximately on the basis of the rotational speed of a delivery device configured as a pump.

In order that the above-mentioned flow paths and flow directions are ensured, it is advantageous for the first line to be provided with a first check valve and for the second line to be provided with a second check valve. The first check valve permits a flow in the direction of the air supply system and blocks in the opposite direction. The second check valve permits a flow in the direction of the intake pipe and likewise blocks in the opposite direction. Both valves open in the flow direction toward the internal combustion engine at the lowest possible differential pressure. The check valve in the first line prevents air from being drawn into the intake pipe from the infeed point upstream of the turbocharger unit during naturally aspirated operation. The check valve in the second line prevents an air flow from the intake pipe upstream of the turbocharger unit during charged operation with a positive pressure in the intake pipe.

It is also advantageous if, in the first line, as an alternative to a check valve, there is arranged a switching valve for selectively switching the fluid flow in the first line in the direction of the air supply system or in the direction of the sorption filter. By means of the switching valve, it is advantageously possible for the admissible flow direction in the first line to be switched, in particular in order to perform leakage diagnosis on the fuel tank. It is advantageously also possible here, correspondingly to the selected flow device, for the associated check valves to be integrated in the switching valve.

To perform a tank leakage diagnosis, the switching valve in the first line is switched such that the first line from the infeed point upstream of the turbocharger unit in the case of a turbocharged engine, or from the infeed point upstream of the throttle device in the case of a naturally aspirated engine, can be traversed by flow in the direction of the delivery device or in the direction of the sorption filter. When the tank venting valve is closed and the sorption filter aeration valve is closed, it is then possible for a positive pressure to be built up in the tank venting system by activating the delivery device. It is possible in this case for coarse leakage diagnosis to be performed if the internal combustion engine is running, and fine leakage diagnosis to be performed if the internal combustion engine is at a standstill, by evaluation of pressure profiles. The pressure profiles are preferably determined by means of a tank pressure sensor. For the fine leakage diagnosis, when a defined positive pressure is reached in the case of the tank venting valve remaining closed, the delivery device is deactivated. It is determined whether the defined positive pressure is maintained. If the pressure is maintained, no leakage is present.

The invention also provides a venting system for a fuel tank, in particular of the type specified above, having a sorption filter for the temporary storage of fuel evaporating from the fuel tank and having a fluid line between the sorption filter and an air supply system of an internal combustion engine, wherein a pressure sensor is arranged on the sorption filter.

Alternatively, the invention provides a venting system for a fuel tank, in particular of the type specified above, having a sorption filter for the temporary storage of fuel evaporating from the fuel tank and having a fluid line between the sorption filter and an air supply system of an internal combustion engine, wherein a pressure sensor is arranged on the fluid line, in particular upstream of a point at which said fluid line divides into a fluid line to the air supply system and a fluid line to the intake pipe.

Pressure sensors arranged in this way are not situated in the fuel tank, such as is the case in conventional tank systems of motor vehicles, but rather are arranged in the region of the sorption filter or in the region of the line between the sorption filter and the tank venting valve, in particular at the outlet of the sorption filter to the regeneration device. By means of such pressure sensors, more precise determination of the regeneration rate is possible. Specifically, it is possible for the pressure difference across the tank venting valve (in particular the pressure difference between sorption filter and intake pipe) to be determined more precisely. This is possible in particular when a pressure which deviates from ambient pressure prevails as a result of a pressure drop across the sorption filter and a possible activation of the delivery device in the first line. Furthermore, the regeneration flow rate generated by means of the delivery device can be determined more precisely. For this purpose, the pressure difference across the delivery device is determined, and then, the delivery rate of said delivery device can be inferred from the pressure difference and rotational speed of the delivery device by means of a characteristic map.

The invention also provides a venting system for a fuel tank, in particular of the type specified above, having a sorption filter for the temporary storage of fuel evaporating from the fuel tank and having a delivery device which is arranged in fluid-conducting fashion between the sorption filter and an air supply system of an internal combustion engine, wherein the delivery device is driven by means of a brushless direct-current motor.

A brushless direct-current motor (brushless DC motor, abbreviated to BLDC or BL motor, or electronically commutated motor, abbreviated to EC motor) is to be understood to mean a direct-current motor type in which the otherwise conventional mechanical commutator with brushes for the current reversal are replaced by an electronic circuit. Furthermore, the stator and rotor are interchanged. The rotor is normally realized by means of a permanent magnet, and the static stator comprises the coils which are actuated in time-offset fashion by means of an electronic circuit in order to generate a rotating field for exerting a torque on the permanently excited rotor.

In the case of brushless direct-current motors, it is possible for the electronic commutation to be made dependent on the rotor position, the rotor rotational speed and the torque. This constitutes a form of direct feedback, whereby the frequency and if appropriate also the amplitude can be varied as a function of the position and the rotational speed of the rotor. This also solves the problem of spark formation as a result of commutation, and provides explosion protection. Furthermore, the delivery device can thereby be regulated in terms of its rotational speed and delivery rates, whereby variable regeneration is made possible. Furthermore, as a result of the electronic commutation, the brushless direct-current motor can be operated forwards and in reverse, whereby the delivery device in the form of a pump can also deliver in both directions. An inexpensive bidirectional delivery device can thus be realized.

The venting system according to the invention of a motor vehicle preferably comprises a fuel tank which is connected in fluid-conducting fashion via a fuel tank connection line to a sorption filter, preferably an activated carbon sorption filter. Said sorption filter temporarily stores volatile substances from the fuel, such as volatile hydrocarbons and other components that are released owing to the pressure and temperature conditions prevailing in the fuel tank, in particular during fuel tank charge processes. The sorption filter is preferably connected in fluid-conducting fashion via a purging line to the air supply system of the internal combustion engine, wherein the delivery device is arranged in the purging line. The delivery device is advantageously in the form of a bidirectional delivery device, in particular a bidirectional pump. The bidirectional delivery device can be selectively switched into a first delivery direction toward the internal combustion engine and into a second delivery direction toward the sorption filter or fuel tank. The bidirectional delivery device is thus configured such that it can deliver fluids in opposite directions. In the present case, “fluids” refers in particular to fuels, fuel-air mixtures and gaseous mixtures of fuel components, such as volatile hydrocarbons, and air.

If the bidirectional delivery device is switched into the delivery direction toward the internal combustion engine, there is generated, in the direction of the air supply or of the intake pipe, a suction action or fluid flow great enough that the sorption filter temporarily enriched with evaporated fuel is regenerated, that is to say substantially completely desorbed, by means of a supplied purging fluid. The sorption filter is “purged” by means of the fluid which may for example be fresh air supplied from the outside. By contrast, if the bidirectional delivery device is switched in the delivery direction toward the sorption filter, it is then preferably the case, both when the internal combustion engine is at a standstill and advantageously also when the internal combustion engine is running, that a positive pressure is built up in the region between the bidirectional delivery device and the fuel tank. A fuel tank leakage diagnosis—on-board diagnosis—can be performed on the basis of determined pressure values.

The venting system according to the invention of said type ensures an efficiency-optimized regeneration of the sorption filter, not least owing to the drive of the delivery device by means of a brushless direct-current motor, and it is also possible in a simple manner to perform an on-board fuel tank leakage diagnosis, such as is prescribed in some countries.

The invention also provides in particular the use of a venting system according to the invention of said type on a motor vehicle.

In one advantageous refinement of the venting system according to the invention, the sorption filter is connected in fluid-conducting fashion via the first line and the delivery device arranged therein to the intake pipe at a first infeed point upstream of a throttle device of the internal combustion engine and is also connected to the intake pipe via the second line and the tank venting valve arranged therein at a second infeed point positioned downstream of the throttle device. Such a refinement is used in particular in the case of naturally aspirated engines. The venting system then in turn has two infeed points by which the evaporated fuel desorbed from the sorption filter can be supplied to the internal combustion engine. The delivery device can in particular advantageously deliver in the direction of the intake pipe and, despite a prevailing intake pipe negative pressure in the case of throttle device being partially or fully closed, in the direction of the sorption filter. It is thus for example also possible for a tank leakage diagnosis, specifically a coarse leakage diagnosis, to be performed while the internal combustion engine is running, during the operation thereof with negative pressure in the intake pipe. Furthermore, during engine operation with a negative pressure in the intake pipe, it is also possible for a regeneration of the sorption filter to be performed only via the tank venting valve, without a pressure drop across the delivery device.

By means of the described arrangement, both in the case of naturally aspirated engines and in the case of turbocharged engines, the flow resistance is reduced during regeneration in operation with a negative pressure in the intake pipe. The regeneration rate of the sorption filter is thereby increased in the case of operation without the delivery device.

It is possible, during charged operation of the internal combustion engine, for a regeneration to take place via the first line by means of a Venturi effect, even with the delivery device deactivated. In the case of high loading of the sorption filter, the delivery device is advantageously operated by means of the easily regulable brushless direct-current motor. On the other hand, it is also possible, during operation with a negative pressure in the intake pipe, for regeneration to take place via the second line without additional flow resistance of the delivery device.

Exemplary embodiments of the solution according to the invention will be explained in more detail below on the basis of the appended drawings, in which:

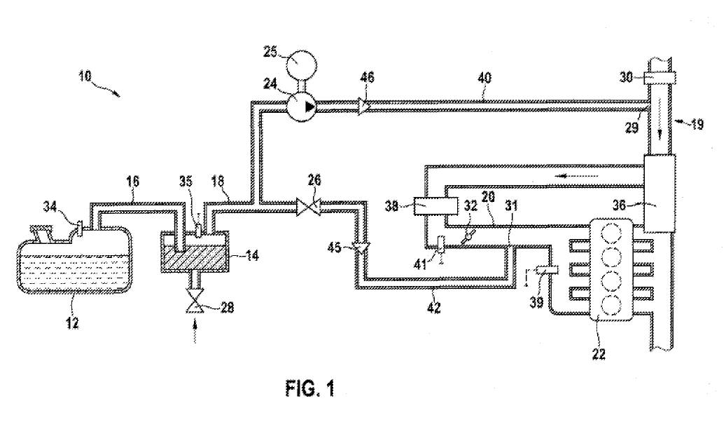

FIG. 1 is a schematic illustration of a first exemplary embodiment of a venting system according to the invention, and

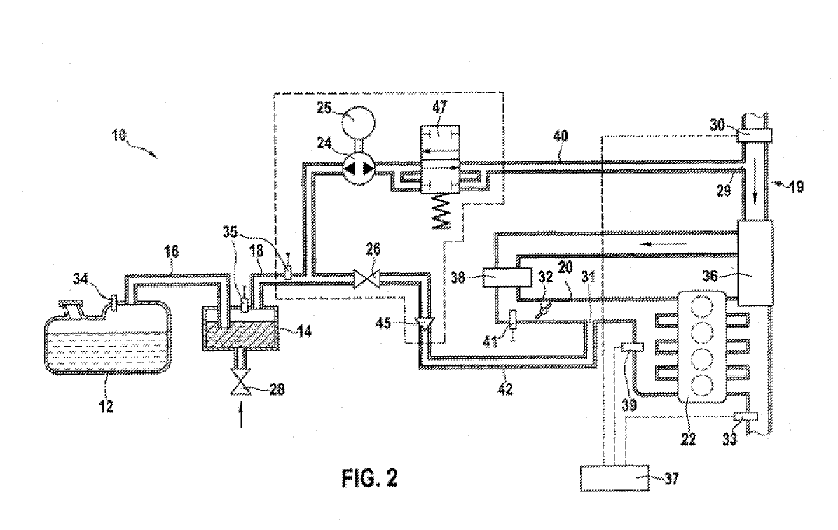

FIG. 2 is a schematic illustration of a second exemplary embodiment of a venting system according to the invention.

### DESCRIPTION OF EMBODIMENTS

FIG. 1 illustrates a venting system 10 of an engine of a motor vehicle. The venting system 10 is coupled to a fuel tank 12 of the motor vehicle, wherein the coupling is established via a sorption filter 14 which serves for the temporary storage of fuel evaporating from the fuel tank 12.

The sorption filter 14 is connected to the fuel tank 12 via a tank connection line 16. Furthermore, the sorption filter 14 is connected in fluid-conducting fashion via a purging line 18 firstly via a first line to an air supply line 19 of the engine, in the present case of an internal combustion engine 22 in the form of a turbocharged engine, and secondly via a second line 42 to an intake pipe 20 of the engine.

In the air supply line 19 there are arranged an air mass sensor 30, a turbocharger unit 36 and a charge-air cooler 38. In the intake pipe 20 there is situated a throttle device 32, which in the present case is in the form of a throttle flap. The air supply line 19 is thus that line section of the air supply system through which the combustion air is supplied to the engine from the outside and which is situated upstream of the charge-air cooler 38 as viewed in the flow direction. The intake pipe 20 forms that line section, for the supply of combustion air from the air supply system, which is situated downstream of the charge-air cooler 38 in terms of flow.

The first line 40 is connected to the air supply line 19 at a first infeed point 29 which is positioned downstream of the air mass sensor 30 in terms of flow and which is positioned upstream of the turbocharger unit 36 in terms of flow. The second line 42 is connected in fluid-conducting fashion to the intake pipe 20 at a second infeed point 31 which is positioned downstream of the throttle device 32 in terms of flow. The first line 40 branches from the second line 42 at the outlet 18 of the sorption filter 14, upstream, as viewed in the direction toward the second infeed point 31, of a tank venting valve 26 arranged in the second line 42. A check valve 45 is arranged in the second line 42, downstream of the tank venting valve 26 as viewed in the flow direction toward the intake pipe 20. In the first line 40 there is arranged a pump 24 which exhibits a unidirectional pumping action in the direction of the first infeed point 29. The pump 24 is driven by means of a brushless direct-current motor 25. Furthermore, a check valve 46 is located in the first line 40 downstream of the pump 24 as viewed in the flow direction.

When the fuel tank 12 is filled with fuel, or when certain pressure and temperature conditions prevail in the fuel tank 12, under which conditions volatile components of the fuel, such as hydrocarbons, change into the gaseous phase, said volatile components are supplied via the tank connection line 16 to the sorption filter 14, and are temporarily stored there. The sorption filter 14 is in the form of an activated carbon filter which can adsorb and resorb the volatile components.

The sorption filter 14 is assigned an aeration opening or an aeration valve 28 which, in the open state, provides fresh air—so-called purging fluid—by means of which the volatile fuel components adsorbed in the sorption filter 14 can be desorbed again.

The pump 24 can be controlled in terms of its delivery rate, by means of a control unit (not illustrated) and the brushless direct-current motor 25, such that, by means of said pump, the sorption filter 14 that has previously been enriched with evaporated fuel is regenerated, that is to say desorbed, in a highly targeted manner, regardless of whether or not a regeneration takes place as a result of intake pipe negative pressure. Thus, fresh air from the atmosphere is drawn via the aeration valve 28 into the purging line 18, and into the first line 40 to the air supply line 19, through the sorption filter 14 that has previously been enriched with evaporated fuel. Here, the air flowing through the filter 14 desorbs the fuel accumulated therein.

The second line 42 is connected to the intake pipe 20 at the second infeed point 31, which is situated downstream of the throttle device 32 as viewed in the flow direction of the combustion air. When there is an adequate negative pressure in the intake pipe 20, the regeneration of the sorption filter 14 takes place (with the pump 24 at a standstill) through the line 42. The regeneration rate into the intake pipe 20 is then controlled by means of the tank ventilation valve 26. The duty cycle thereof is calculated, using the pressure difference at the tank venting valve 26, from the intake pipe pressure measured by means of an intake pipe pressure sensor 39 and the ambient pressure. Since substantially ambient pressure prevails in the fuel tank 12 and in the sorption filter 14, the ambient pressure can advantageously be measured by means of a pressure sensor 34 arranged in the fuel tank or by means of a pressure sensor 35 arranged on the sorption filter 14. The regeneration by means of the tank venting valve 26 takes place with the pump 24 being bypassed, such that the flow resistance thereof cannot adversely affect said regeneration flow.

The pump 24 is thus activated only if there is insufficient negative pressure in the intake pipe. The desorption of the sorption filter 14 by means of the pump 24 takes place preferably when the internal combustion engine 22 is having to generate high levels of power, for example during relatively long periods of uphill driving, that is to say when the throttle device 32 is open. The pump 24 and in particular the brushless direct-current motor 25 thereof thus permit demand-oriented regeneration of the sorption filter 14, whereby the power consumption of the brushless direct-current motor 25 can be minimized. The rotational speed of the pump 24 can be continuously increased by means of the brushless direct-current motor 25, and it is thereby possible for the regeneration rate in the line 40 to be controlled in continuously variable fashion. It is possible here for the regeneration rate to be determined approximately on the basis of the pump rotational speed of the pump 24.

FIG. 2 shows an embodiment of the venting system 10 which is expanded with regard to the leakage diagnosis and in which it is likewise the case that the sorption filter 14 is connected in fluid-conducting fashion to the air supply line 19 via the first line 40 and the second line 42 is connected in fluid-conducting fashion to the intake pipe 20 of the internal combustion engine 22. Here, the first line 40 again issues into the air supply line 19 at a first infeed point 29 which is positioned upstream of the turbocharger unit 36, and the second line 42 issues into the intake pipe 20 at a second infeed point 31 which is positioned downstream of the throttle device 32.

The pump 24 as per FIG. 2 is in the form of a bidirectional pump, and a switching valve 47 is arranged in the first line 40 instead of the check valve 46. The switching valve 47 is a two-position valve which, in one position, opens up a flow direction toward the infeed point 29, and in the other position, opens up a flow direction toward the pump 24, but in each case blocks a flow through the line 40 in the opposite direction by means of integrated check valves.

For the regeneration of the sorption filter 14, the switching valve 47 is switched into the pass-through direction toward the infeed point 29. Firstly, it is now possible during charged operation of the internal combustion engine 22 for the sorption filter 14 to be regenerated, with the pump 24 deactivated, via the first line 40 by means of a Venturi effect. In the case of a high loading of the sorption filter 14, the bidirectional pump 24 is switched in the delivery direction toward the infeed point 29, and thus the regeneration rate is increased. On the other hand, when the internal combustion engine 22 is in naturally aspirated operation, regeneration into the intake pipe 20 can take place via the second line 42, without the flow resistance of the pump 24, owing to the negative pressure in the intake pipe. The regeneration rate of the sorption filter 14 is in this case controlled by means of a clock-pulse behavior of the tank venting valve 26.

To perform on-board fuel tank leakage diagnosis, the switching valve 47 is switched into the pass-through direction toward the pump 24, and, with the internal combustion engine 22 at a standstill, the bidirectional pump 24 delivers fluid, in particular fresh air that has to be supplied from the outside via the intake path of the internal combustion engine 22 and the air supply line 19, in the direction of the fuel tank 12. Here, a positive pressure is generated in all regions between the pump 24 and the fuel tank 12 with the aeration valve 28 closed and the tank venting valve 26 closed. Subsequently, a pressure sensor 34 arranged in the fuel tank 12, or a pressure sensor 35 arranged on the sorption filter 14 or on the line 42 upstream of the tank venting valve 29, determines the pressure in said region over a certain period of time. In this way, it is possible to identify any leakage in the venting system 10. Coarse leakage diagnosis is possible when the engine is running, and fine leakage diagnosis is possible when the engine is at a standstill.

With the delivery of regeneration gas from the sorption filter 14 into the line 40 by means of the pump 24, fluid is introduced into the air supply line 19 upstream of the turbocharger unit 36, without said fluid having been measured by the air mass sensor 30. If said regeneration gas flow is substantially saturated with fuel, a correction of a lambda regulator can be identified. For said identification, an evaluation unit 37 is provided which is set up to determine a signal variation of the air mass flow sensor 30 in relation to the lambda regulator 33. Since said check is possible even in the case of low air throughputs and with a capability for separate deactivation of the second line 42 to the intake pipe 20, it is possible to realize very precise diagnosis even of a partially blocked or partially open line 40 or infeed point 29.

If the regeneration gas is pure air, the charge signal of the air mass sensor 30 can be compared, by the evaluation device, with the charge signal of the intake pipe pressure sensor 39 arranged on the intake pipe 20 or of the throttle device sensor mounted on the throttle device 32. The air mass sensor 30 does not measure the air injected by the pump 24. Therefore, the charge signal of the air mass sensor 30 is lower than the charge signal of the intake pipe pressure sensor 39 or of the throttle device sensor mounted on the throttle device 32. In particular by means of cyclic activation and deactivation of the pump 24 in the case of intake pipe pressures around or higher than ambient pressure and by means of correlation of the signals of the lambda regulator 33 and of the charge difference between air mass sensor and intake pipe pressure sensor with the actuation sequence of the pump 24, it is possible to identify a situation in which the line 40 has fallen off or become blocked.

In states of high loading of the sorption filter 14, such as are encountered at the start of an exhaust-gas test, it is provided that, with the internal combustion engine 22 at idle or in the part-load range, regeneration is firstly performed via the tank venting valve 26 into the intake pipe 20, without the pump 24 being operated, and in the process the loading of the sorption filter 14 is measured by means of the lambda regulator 33. Thereafter, the tank venting valve 26 is closed and, likewise at idle or in the part-load range, the same regeneration rate is introduced upstream of the turbocharger unit 36 by means of the pump 24. Then, after a settling process, approximately the same loading as that from the previously determined lambda regulator correlation during the regeneration into the intake pipe 20 must be encountered.

During the tank leakage diagnosis, the air mass sensor 30 measures an additional air mass which does not flow into the internal combustion engine 22. The charge signal of the air mass sensor 30 is thus correspondingly greater than a charge signal of the intake pipe pressure sensor 39.

At the end of the tank leakage diagnosis, after a defined positive pressure is attained, the aeration valve 28 can be opened with a slight delay after the switching valve 47 is switched back, and the pump 24 pumps regeneration gas to the infeed point 29 downstream of the air mass sensor 30 with assistance from the positive pressure from the tank venting system. The internal combustion engine 22 then again receives additional air not measured by the air mass sensor 30, specifically to an increased extent because the pump 24 is assisted by the positive pressure in the tank venting system. The charge signal of the air mass sensor 30 thus becomes smaller than that of the intake pipe pressure sensor 39. By means of the flow reversal, the measurement effect thus becomes more than twice as great as in the case of non-bidirectional delivery. The selectivity thus attained generally also makes it possible to identify only partially blocked lines.

Alternatively or in addition, it is possible, with the internal combustion engine 22 at a standstill, for the signal of the air mass sensor 30 to be evaluated during the tank leakage diagnosis. Since it is then the case that no air is drawn in by the internal combustion engine 22 which is at a standstill, it is possible from the profile with respect to time of the signal of the air mass sensor 30 to determine precisely the volume flow rate drawn off by the pump 24. A highly accurate identification of all possible faults, even of a partially closed-off line 40, is thus possible.

Furthermore, in the case of a system as illustrated in FIG. 2, which system is then equipped not with an air mass sensor 30 but with a charge pressure sensor 41 arranged between the charge-air cooler 38 and the throttle device 32, a detection of faults on the line 40 can take place, with the internal combustion engine at a standstill, during a drawing-off process by means of the pump 24. Owing to the flow resistance of an air filter (not illustrated) arranged upstream of the air supply line 19, a slight negative pressure is generated at the charge pressure sensor 41 upstream of the throttle device 32 during the drawing-off process. Said negative pressure can be measured as a change in the level of the profile with respect to time of the signal of the charge pressure sensor 41. To improve the measurement effect, it may be advantageous to perform multiple pumping-off processes with interposed venting processes.

1. A venting system for a fuel tank, comprising:
a sorption filter configured to temporarily store fuel evaporating from the fuel tank; and
a delivery device arranged in fluid-conducting fashion between the sorption filter and an air supply system of an internal combustion engine,
wherein the internal combustion engine is a turbocharged engine including a turbocharger unit and a throttle device in the air supply system,
wherein the sorption filter is connected in fluid-conducting fashion via (i) a first line to the air supply system at a first infeed point positioned upstream of the turbocharger unit and (ii) a second line to the air supply system at a second infeed point positioned downstream of the throttle device, and
wherein a tank venting valve is arranged in the second line, and the first line branches from the second line upstream of the tank venting valve as viewed in the flow direction to the second infeed point.

2. The venting system as claimed in claim 1, wherein the first line is configured with a first check valve and the second line is configured with a second check valve.

3. The venting system as claimed in claim 1, wherein the first line includes a switching valve arranged therein, the switching valve being configured to selectively switch the fluid flow in the first line in the direction of the air supply system or in the direction of the sorption filter.

4. A venting system for a fuel tank, comprising:
a sorption filter configured to temporarily store fuel evaporating from the fuel tank;
a fluid line disposed between the sorption filter and an air supply system of an internal combustion engine; and
a pressure sensor is arranged on the sorption filter.

5. A venting system for a fuel tank, comprising:
a sorption filter configured to temporarily store fuel evaporating from the fuel tank;
a fluid line disposed between the sorption filter and an air supply system of an internal combustion engine; and
a pressure sensor arranged on the fluid line.

6. The venting system as claimed in claim 1, wherein the delivery device is driven by a brushless direct-current motor.

7. The venting system as claimed in claim 6, wherein the delivery device is configured as a bidirectional delivery device.

8. The venting system as claimed in claim 1, wherein the venting system is used on a motor vehicle.

9. The venting system as claimed in claim 4, further comprising:
a delivery device arranged in fluid-conducting fashion between the sorption filter and the air supply system of the internal combustion engine,
wherein the internal combustion engine is a turbocharged engine including a turbocharger unit and a throttle device in the air supply system,
wherein the fluid line includes (i) a first line connected in fluid-conducting fashion to the air supply system at a first infeed point positioned upstream of the turbocharger unit and (ii) a second line connected in fluid-conducting fashion to the air supply system at a second infeed point positioned downstream of the throttle device, and
wherein a tank venting valve is arranged in the second line, and the first line branches from the second line upstream of the tank venting valve as viewed in the flow direction to the second infeed point.

10. The venting system as claimed in claim 5, further comprising:
a delivery device arranged in fluid-conducting fashion between the sorption filter and the air supply system of the internal combustion engine,
wherein the internal combustion engine is a turbocharged engine including a turbocharger unit and a throttle device in the air supply system,
wherein the fluid line includes (i) a first line connected in fluid-conducting fashion to the air supply system at a first infeed point positioned upstream of the turbocharger unit and (ii) a second line connected in fluid-conducting fashion to the air supply system at a second infeed point positioned downstream of the throttle device, and
wherein a tank venting valve is arranged in the second line, and the first line branches from the second line upstream of the tank venting valve as viewed in the flow direction to the second infeed point.

11. The venting system as claimed in claim 7, wherein the delivery device is configured as a bidirectional pump.
